(19) United States
(12) Patent Application Publication
(10) Pub. No.: US 2024/0135913 A1
(43) Pub. Date: Apr. 25, 2024

(54) ACTIVE NOISE REDUCTION HEADPHONES AND METHOD

(71) Applicant: HUAWEI TECHNOLOGIES CO., LTD., Shenzhen (CN)

(72) Inventors: Liyun Pang, Munich (DE); Fons Adriaensen, Munich (DE); Song Li, Hannover (DE); Roman Schlieper, Hannover (DE)

(21) Appl. No.: 18/400,971

(22) Filed: Dec. 29, 2023

Related U.S. Application Data
(63) Continuation of application No. PCT/EP2021/068023, filed on Jun. 30, 2021.

(51) Int. Cl. G10K 11/178

(52) U.S. Cl. CPC G10K 11/17854; G10K 2210/1081

(57) ABSTRACT

ANR headphones generate a sound signal, and include a loudspeaker, an external microphone configured to detect an ambient noise signal, and an internal microphone configured to detect a residual noise signal within an ear canal of the user. Moreover, the ANR headphones have an acceleration sensor configured to generate an acceleration signal indicative of accelerations experienced by the ANR headphones. A controller of the ANR headphones is configured to generate a loudspeaker signal based on a composite compensation signal. The composite compensation signal is a combination of an ambient noise compensation signal based on the ambient noise signal, a residual noise compensation signal based on the residual noise signal and an acceleration compensation signal based on the acceleration signal.

### CROSS-REFERENCE TO RELATED APPLICATIONS

This application is a continuation of International Application No. PCT/EP2021/068023, filed on Jun. 30, 2021, the disclosure of which is hereby incorporated by reference in its entirety.

### FIELD

The present disclosure relates to audio processing in general. More specifically, the disclosure relates to active noise reduction (ANR) headphones as well as a method for operating ANR headphones.

### BACKGROUND

Acoustically closed headphones allow a good attenuation of the outside ambient noise and, thus, achieve a good audio reproduction quality. This results in a higher isolation of the user from its environment and an increased acoustic impedance between the inside of the ear (e.g. the ear canal) and the outside environment. An increased acoustic impedance can results in an increased sound pressure level (SPL) for low frequencies inside the ear canal of the user. In the case of self-generated sound by the user, the perceived sound may feel unnaturally amplified at low frequencies. This phenomenon is referred to as the occlusion effect (OE). In addition to the perception of own voice, the OE can also be caused by physical activities of the user, like running, walking, etc.

To counteract the occlusion effect it has been suggested to provide small ducts which connect the inside of the ear canal to the environment, which can be considered to be a passive solution. An active solution to counteract the occlusion effect may be to use active noise reduction (ANR) schemes (also referred to as active noise cancellation (ANC) schemes) for reducing the sound pressure level in the ear canal of the user. Another active solution is employing a hear-through function which increases the sound pressure level of air-conducted sounds to compensate for the passive damping due to the headphone housing.

### SUMMARY

Headphones and methods according to this disclosure allow improved ANR headphones as well as an improved method of operating ANR headphones.

According to a first aspect, active noise reduction, ANR, headphones for generating a sound signal in an ear canal of a user are provided. The ANR headphones comprise a loudspeaker configured to be driven by a loudspeaker signal for generating the sound signal, an external microphone (also referred to as reference microphone) configured to detect an ambient noise signal, and an internal microphone (also referred to as error microphone) configured to detect a residual noise signal. The residual noise signal may be detected within the ear canal of the user. Furthermore, the ANR headphones comprise an acceleration sensor configured to generate an acceleration signal indicative of one or more accelerations experienced by the ANR headphones. A controller of the ANR headphones is configured to generate the loudspeaker signal based on a composite compensation signal, wherein the composite compensation signal is a combination of an ambient noise compensation signal based on the ambient noise signal, a residual noise compensation signal based on the residual noise signal and an acceleration compensation signal based on the acceleration signal. The AND headphones may comprise a single headphone or at least one headphone.

Thus, the ANR headphones allow compensating for the occlusion effect caused, for instance, by physical activities of the user by combining a feed-forward control based on the acceleration signal provided by the acceleration sensor and a feedback control based on acoustic data.

In a possible implementation form, the controller is configured to generate the loudspeaker signal based on the composite compensation signal and an audio input signal. The audio input signal may be, for instance a stereo signal. Thus, the ANR headphones allow compensating for the occlusion effect, while reproducing an audio input signal.

In a possible implementation form, the controller is configured to generate the ambient noise compensation signal based on the ambient noise signal by applying a fixed or adaptive ambient noise feedforward, FF, filter to the ambient noise signal.

In a possible implementation form, the controller is configured to generate the residual noise compensation signal based on the residual noise signal by applying a fixed or adaptive feedback, FB, filter to the ambient noise signal.

In a possible implementation form, the controller is configured to generate the acceleration compensation signal based on the acceleration signal by applying an acceleration feedforward, FF, filter to the acceleration signal.

In a possible implementation form, the acceleration FF filter is a fixed acceleration FF filter comprising a plurality of fixed filter coefficients, wherein the plurality of fixed filter coefficients of the fixed acceleration FF filter are based on a solution of the Wiener-Hopf equation.

In a possible implementation form, the plurality of fixed filter coefficients W_{ACC} of the fixed acceleration FF filter are based on the following equation:

W_{ACC}=Ψ_{gg}⁻¹ϕ_{hg},
wherein Ψ_{gg} denotes an auto-correlation matrix for the impulse response of the communication channel between the loudspeaker and the internal microphone and ϕ_{hg} denotes a cross-correlation vector between the impulse response and the impulse response of the communication channel between the acceleration sensor and the internal microphone.

In a possible implementation form, the ANR headphones further comprise a memory configured to store the plurality of fixed filter coefficients W_{ACC} of the fixed acceleration FF filter.

In a possible implementation form, the impulse response of the communication channel between the acceleration sensor and the internal microphone is based on measurements of the residual noise signal in response to one or more pre-determined accelerations of the ANR headphones. For instance, these measurements may be performed by exciting a shaker, wherein the ANR headphones are fitted on a dummy head mounted on the shaker.

In a possible implementation form, the impulse response of the communication channel between the acceleration sensor and the internal microphone is based on measurements of the residual noise signal in response to one or more measured accelerations of the ANR headphones. For instance, these measurements may be performed by having the user wearing the ANR headphones perform one or more physical activities, such as walking.

In a possible implementation form, the acceleration feedforward, FF, filter is an adaptive filter comprising a plurality of adaptive filter coefficients.

In a possible implementation form, the controller is configured to determine the plurality of adaptive filter coefficients on the basis of a Filtered-x Least Mean Square (FxLMS) algorithm.

In a possible implementation form, the controller is configured to adjust the plurality of adaptive filter coefficients, if the adjustments of the plurality of adaptive filter coefficients are within one or more pre-defined allowed ranges.

In a possible implementation form, the ANR headphones further comprise an elastic housing configured to be inserted in the ear canal of the user. The elastic housing allows to acoustically close the ear canal of the user and, thus, to reduce the remaining noise within the ear canal.

According to a second aspect a method for operating active noise reduction, ANR, headphones for generating a sound signal in an ear canal of a user. The method comprises:
driving a loudspeaker by a loudspeaker signal for generating the sound signal;
detecting an ambient noise signal by an external microphone;
detecting a residual noise signal in the vicinity of the ear of the user by an internal microphone;
generating by an acceleration sensor an acceleration signal indicative of one or more accelerations experienced by the ANR headphones; and
generating the loudspeaker signal based on a composite compensation signal, wherein the composite compensation signal is a combination of an ambient noise compensation signal based on the ambient noise signal, a residual noise compensation signal based on the residual noise signal and an acceleration compensation signal based on the acceleration signal.

The method according to the second aspect of the present disclosure can be performed by the ANR headphones according to the first aspect of the present disclosure. Thus, further features of the method according to the second aspect result directly from the functionality of the ANR headphones according to the first aspect as well as its different implementation forms described above and below. In other words, further features and implementation forms of the method according to the second aspect correspond to the features and implementation forms of the ANR headphones according to the first aspect.

According to a third aspect, a computer program product is provided comprising a computer-readable storage medium for storing program code which causes a computer or a processor to perform the method according to the second aspect when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows a schematic diagram illustrating ANR headphones according to an embodiment;

FIG. 2 shows a schematic diagram illustrating a fixed feedforward filter implemented by the ANR headphones according to an embodiment;

FIG. 3 shows a schematic diagram illustrating an adaptive feedforward filter implemented by the ANR headphones according to an embodiment;

FIG. 4 shows a schematic diagram illustrating a fixed feedback filter implemented by the ANR headphones according to an embodiment;

FIG. 5 shows a schematic diagram illustrating an adaptive feedback filter implemented by the ANR headphones according to an embodiment;

FIG. 6 shows a schematic diagram illustrating a fixed acceleration filter implemented by the ANR headphones according to an embodiment;

FIG. 7 shows a schematic diagram illustrating a setup for determining a fixed acceleration filter implemented by the ANR headphones according to an embodiment;

FIG. 8 shows exemplary acceleration measurements for determining a fixed acceleration filter implemented by the ANR headphones according to an embodiment;

FIG. 9 shows a schematic diagram illustrating an adaptive acceleration filter implemented by the ANR headphones according to an embodiment;

FIG. 10 shows exemplary acceleration measurements for determining an adaptive acceleration filter implemented by the ANR headphones according to an embodiment;

FIG. 11 shows the noise reduction performance as a function of frequency for the ANR headphones according to an embodiment; and

FIG. 12 shows a flow diagram illustrating a method of operating ANR headphones according to an embodiment.

In the following, identical reference signs refer to identical or at least functionally equivalent features.

### DETAILED DESCRIPTION

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

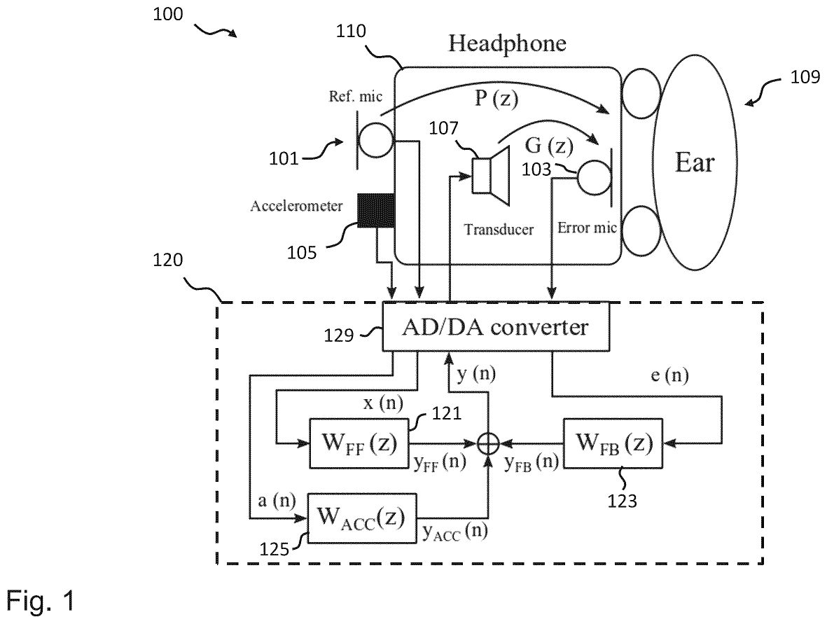

FIG. 1 shows a schematic diagram illustrating ANR headphones 100 according to an embodiment configured to generate a sound signal in an ear canal of a user. As will be described in more detail below, embodiments of the ANR headphones 100 disclosed herein employ an acceleration sensor 105 (also referred to as accelerometer or vibration sensor) to pick up low frequency signals caused by physical activities and compensate the occlusion effect (OE) at low frequencies in a feedforward manner. The acceleration sensor 105 may be used to detect the movement pattern of the user of the ANR headphones 100 which is then used to calculate a compensation signal for reducing the OE. A feedback ANR filter 123 may further reduce the OE, since the OE sound is mainly transmitted by bone conduction and there are almost no air-conducted components.

The ANR headphones 100 comprise a loudspeaker 107 (also referred to as transducer 107) configured to be driven by an analog version of a digital loudspeaker signal y(n) for generating a sound signal, an external microphone 101 (also referred to as reference microphone 101) configured to detect an analog version of a digital ambient noise signal x(n) and an internal microphone 103 (also referred to as error microphone 103) configured to detect an analog version of a digital residual noise signal e(n) within the ear canal of the user, e.g. in the vicinity of the ear 109 of the user. As will be appreciated, while the internal microphone 103 is located together with the loudspeaker 107 in the acoustically closed space defined by an elastic housing 110 of the ANR headphones 100 inserted into the user's ear canal, the external microphone 101 is located outside thereof in order to sense the ambient noise signal.

The ANR headphones 100 further comprise the acceleration sensor 105 configured to generate an analog version of a digital acceleration signal a(n) indicative of one or more accelerations experienced by the ANR headphones 100 over time. The ANR headphones 100 further comprise an audio controller 120 configured to generate the digital loudspeaker signal y(n) based on a composite compensation signal. The composite compensation signal is a combination, for instance, a sum of an ambient noise compensation signal y_{FF}(n) based on the ambient noise signal x(n), a residual noise compensation signal y_{FB}(n) based on the residual noise signal e(n) and an acceleration compensation signal y_{ACC}(n) based on the acceleration signal a(n) In an embodiment, the audio controller 120 is configured to generate the loudspeaker signal y(n) based on the composite compensation signal and an audio input signal the user wants to listen to. In the embodiment shown in FIG. 1 the ANR headphones further comprise an AD/DA converter 129 configured to transform a respective analog signal into a digital signal and vice versa.

As will be described in more detail below, in an embodiment, the audio controller 120 is configured to generate the ambient noise compensation signal y_{FF}(n) based on the ambient noise signal x(n) by applying a fixed or adaptive ambient noise feedforward, FF, filter 121 to the ambient noise signal x(n). As illustrated in the embodiment shown in FIG. 1, the audio controller 120 may be further configured to generate the residual noise compensation signal y_{FB}(n) based on the residual noise signal e(n) by applying a fixed or adaptive feedback, FB, filter 123 to the ambient noise signal x(n). In an embodiment, the audio controller 120 is further configured to generate the acceleration compensation signal y_{ACC}(n) based on the acceleration signal a(n) by applying an acceleration feedforward, FF, filter 125 to the acceleration signal a(n).

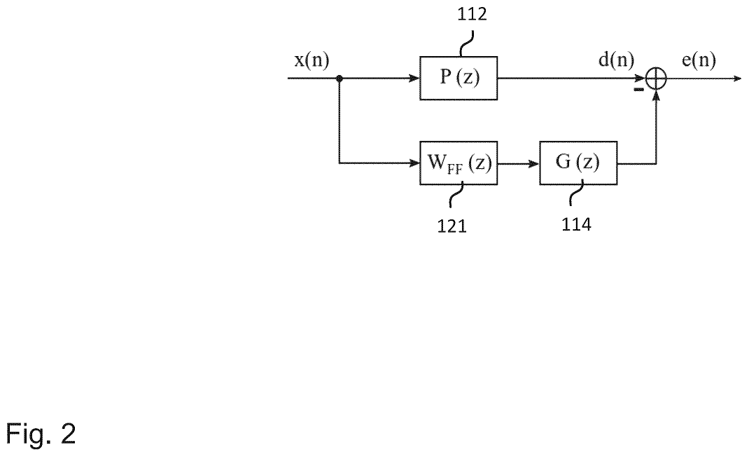

FIG. 1 (as well as FIG. 2) shows the impulse response P(z) 112 (also referred to as acoustic transfer function) of the acoustic communication path (i.e. the primary path) between the external microphone 101 and the internal microphone 103, while G(z) 114 denotes the impulse response of the communication channel (i.e. the secondary channel) between the loudspeaker 107 and the internal microphone 103.

FIG. 2 illustrates an embodiment of the ANR FF filter 121 of the controller 120 of the ANR headphones 100 as a fixed FF filter, i.e. a filter having constant, e.g. pre-defined filter coefficients. As illustrated in FIG. 2, the ambient noise signal x(n) recorded by the external microphone 101 is passed through the appropriately designed fixed FF filter W_{FF}(Z) 121 for generating the ambient noise compensation signal y_{FF}(n). As part of the composite compensation signal the ambient noise compensation signal y_{FF}(n) is played back via the loudspeaker 107 of the ANR headphones 100 and affected by the acoustic transfer function G(z) 114 of the secondary path between the loudspeaker 107 and the internal microphone 103, wherein the ambient noise compensation signal y_{FF}(n) compensates the ambient noise signal x(n) distorted by the acoustic transfer function P(z) 112 of the primary path between the external microphone 101 and the internal microphone 103. In an embodiment, the fixed FF filter W_{FF}(z) 121 for generating the ambient noise compensation signal y_{FF}(n) may be designed offline according to control theory.

As will be appreciated, a causal approximation of the optimally designed fixed FF filter W_{FF}(z) 121 shown in FIG. 2 may be obtained by solving the Wiener-Hopf equation:

W_{FF,optimal}=Ψ_{gg}⁻¹ϕ_{pg},

where Ψ_{gg} denotes the auto-correlation matrix for the impulse response G(z) 114 of the secondary path between the loudspeaker 107 and the internal microphone 103, and ϕ_{pg} denotes the cross-correlation vector between the impulse responses P(z) 112 of the primary path and G(z) 114 of the secondary path.

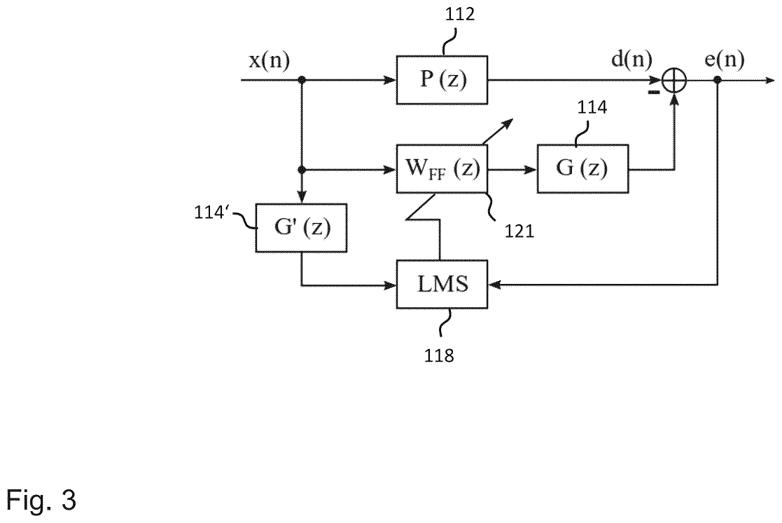

FIG. 3 illustrates an embodiment of the ANR FF filter 121 of the controller 120 of the ANR headphones 100 as an adaptive FF filter, i.e. a filter having adaptive filter coefficients that may vary over time. In the embodiment shown in FIG. 3 the adaptive FF filter W_{FF}(Z) 121 is based on a filtered-x least mean square (FxLMS) algorithm. As illustrated in FIG. 3, the adaptive FF filter W_{FF}(z) 121 may be updated in real-time based on the recorded ambient noise signal x(n) and the residual noise signal, i.e. the error signal e (n). The recorded ambient noise signal x(n) may be first filtered through an estimated secondary path G′ (z) 114′, which is an approximation of the acoustic transfer path G(z) 114 between the loudspeaker 107 and the internal microphone 103. Then, the filtered ambient noise signal x(n) and the residual noise signal e(n) are fed into a LMS (least mean square) processing block 118 implemented by the controller 120 for estimating the acoustic transfer function of the adaptive FF filter W_{FF}(z) 121. The recorded ambient noise signal x(n) is filtered by the estimated adaptive FF filter W_{FF}(Z) 121 and reproduced with the loudspeaker 107.

In an embodiment, the FxLMS algorithm implemented by the controller 120 of the ANR headphones 100 in the LMS processing block 118 can be expressed as:

e(n)=d(n)−g^{T}(n)[w^{T}(n)x(n)],

w_{FF}(n+1)=w_{FF}(n)−μ[g′^{T}(n)x(n)]e(n),
where n denotes a discrete time index, g(n) and g′(n) are the real and approximated impulse responses of the secondary path 114, respectively, w(n)=[w₀(n), W₁(n), . . . , w_{L-1}(n)] is the coefficient of the adaptive FF filter W_{FF}(Z) 121 with a filter order of L, x(n)=[x(n), x(n−1), x(n−2), . . . x(n−L+1)] is the recorded ambient noise signal vector consisting of the last L samples at time n, and μ denotes the step-size of the adaption process. In an embodiment, the controller 120 of the ANR headphones 100 may be configured to implement a leaky FxLMS algorithm, a FxNLMS algorithm, a band limited FxLMS algorithm, a Kalman-filter based adaptive algorithm and the like for estimating the adaptive FF filter W_{FF}(Z) 121.

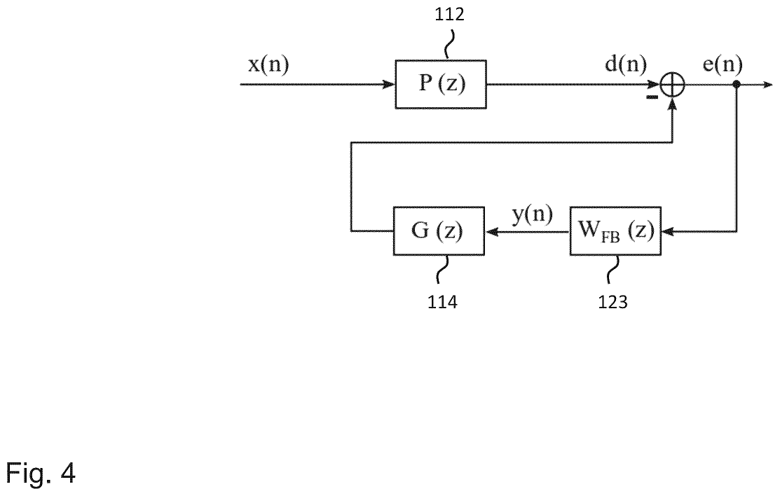

FIG. 4 illustrates an embodiment of the ANR FB filter 123 of the controller 120 of the ANR headphones 100 as a fixed FB filter, i.e. a filter having constant, e.g. pre-defined filter coefficients. As illustrated in FIG. 4, the residual noise signal e (n) may be used by the controller 120 to synthesize the residual noise compensation signal y F B (n). As will be appreciated from FIG. 4, contrary to the FF filter 121 the ANR FB filter W_{FB}(z) 123 does not require the ambient noise signal x(n) measured by the external microphone 101.

As illustrated in FIG. 4, the ANR FB filter W_{FB}(Z) 123 may be designed based on the acoustic transfer path G (z) 114 between the loudspeaker 107 and the internal microphone 103. A sensitivity function S(z) between the desired signal d (n) and the residual noise signal e(n) may be minimized to achieve a high attenuation performance. On the other hand, the complementary sensitivity function T(z)=1−S(z) represents the robustness of the filter 123. In an embodiment, the filter W_{FB}(Z) 123 may be designed such that the complementary sensitivity function T(z)=1−S(z) is relatively small compared with the measurement noise to guarantee the stability of the FB filter system. Thus, in an embodiment, a trade-off between the performance and the robustness may be made. In an embodiment, mixed-sensitivity H∞ synthesis algorithms may be applied that take these two criteria into account.

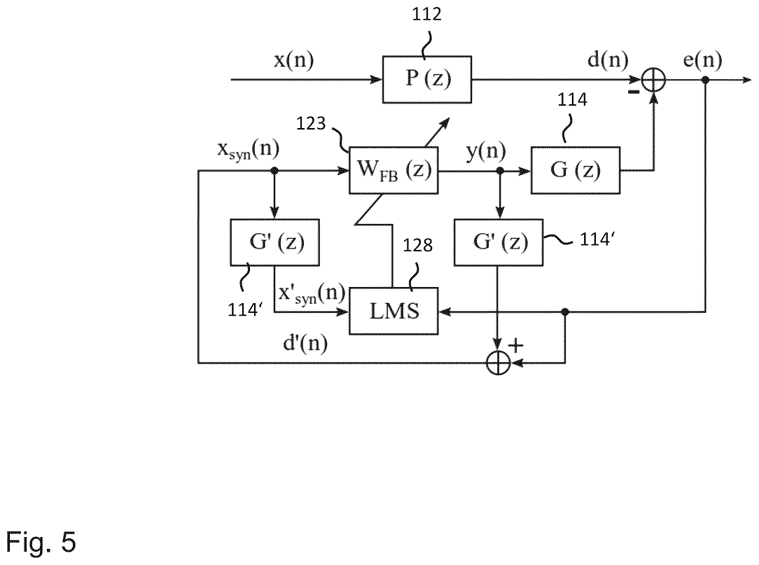

FIG. 5 illustrates an embodiment of the ANR FB filter 123 of the controller 120 of the ANR headphones 100 as an adaptive FB filter, i.e. a filter having adaptive filter coefficients that may vary over time. In the embodiment shown in FIG. 5 the adaptive FB filter W_{FB}(z) 123 is based on a filtered-x least mean square (FxLMS) algorithm. As illustrated in FIG. 5, the basic idea of the adaptive FB ANC W_{FB}(Z) 123 is to predict the ambient noise signal, i.e. the reference signal x(n). In an embodiment, the predicted or synthesized reference signal, x_{syn}(n) may be determined as follows:

x_{syn}=e(n)+[g′^{T}(n)y(n)].

Under ideal conditions, i.e., g′(n)=g(n), the adaptive FB ANC filter system shown in FIG. 5 is equivalent to the adaptive FF system shown in FIG. 3. In an embodiment, one or more FxLMS based adaptive filtering algorithms may be used for determining the adaptive FB ANC W_{FB}(z) 123.

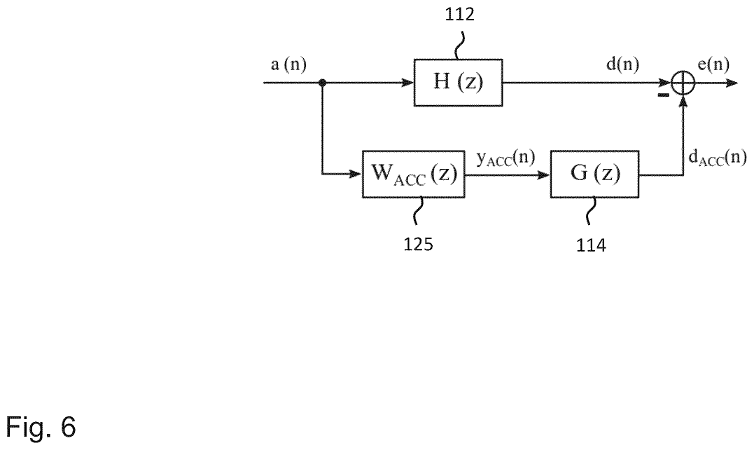

FIG. 6 illustrates an embodiment of the acceleration feedforward, FF, filter 125 as a fixed FF ACC filter 125 for generating the acceleration compensation signal y_{ACC}(n) based on the acceleration signal a(n). As will be appreciated from the following, the algorithms for determining the fixed (as well as the adaptive) FF ACC filter W_{ACC}(Z) 125 may be very similar to those for determining the fixed (or adaptive) FF filter 121 described above. The main difference is that the input signal for the FF ACC filter W_{ACC}(Z) 125 is the measured acceleration signal a(n) and not the ambient noise signal, i.e. the reference signal x(n). In an embodiment, the acceleration sensor 105 is configured to record acceleration signals for different directions, for instance, for an x (back-front), y (up-down), and z (left-right) direction. As already described, based on these acceleration signals the FF ACC filter W_{ACC}(z) 125 is configured to generate the acceleration compensation signal y_{ACC}(n). In FIG. 6 H(z) 112 denotes the impulse response, i.e. the acoustic transfer function of the acoustic communication path(s) between the acceleration sensor 105 and the internal microphone 103.

As can be taken from FIG. 6, the FF ACC filter W_{ACC}(Z) 125 generates the acceleration compensation signal y_{ACC}(n) in such a way to minimize the disturbance signal d(n) caused by any accelerations or vibrations of the ANR headphones 100, as indicated by the acceleration signal a(n). As in the case of the fixed FF ANR filter W_{FF}(z) 121 described above, in an embodiment the FF ACC filter W_{ACC}(Z) 125 may be determined on the basis of the Wiener-Hopf equation:

W_{ACC,optimal}=Ψ_{gg}⁻¹ϕ_{hg},

where Ψ_{gg} describes the auto-correlation matrix for the impulse response G(z) 114 and ϕ_{pg} represents the cross-correlation vector between the impulse responses H(z) 112 and G(z) 114. In the following it will be described how the impulse response H(z) 112 of the acoustic communication path(s) between the acceleration sensor 105 and the internal microphone 103 may be determined and the FF ACC filter W_{ACC}(Z) 125 on the basis thereof.

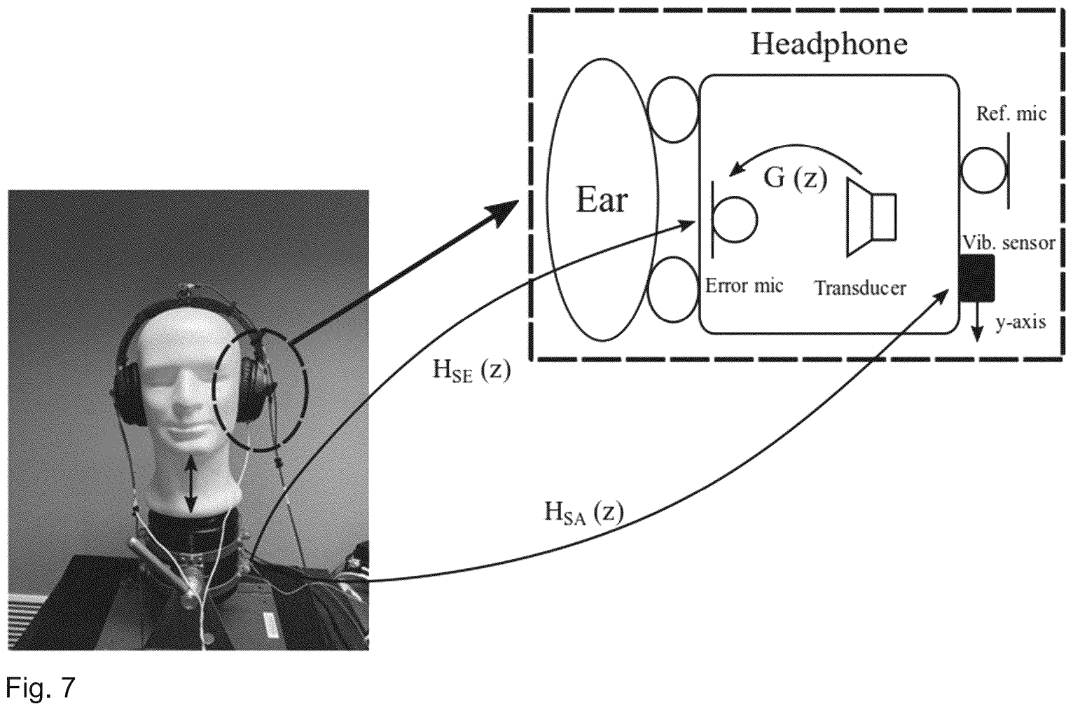

FIG. 7 shows a schematic diagram illustrating a first possible setup for determining the impulse response H(z) 112 and the FF ACC filter W_{ACC}(Z) 125. As illustrated in FIG. 7, the impulse response H(z) 112 may be determined by mounting the ANR headphones 100 on a dummy head and moving the dummy head by means of a shaker with a pred-defined excitation signal. In an embodiment, the shaker may be excited in the vertical direction (up and down), which is the main direction of vibrations during physical activities, such as running and walking. More specifically, the ANR headphones 100 may be mounted on the dummy head, which, in turn, is mounted on the shaker. In an embodiment, the shaker may be excited, for instance with an exponential sweep signal (e.g., from 20 Hz to 1 kHz). The transfer function between the shaker and the acceleration sensor 105 H_{SA}(z), and the transfer function between the shaker and the internal microphone 130 H_{SE}(z) can be determined using a deconvolution method. The transfer function H(z) 112 between the acceleration sensor 105 and the internal microphone 103 may be determined as the ratio of H_{SA}(z) and H_{SE}(z). In a further stage, the fixed FF ACC filter W_{ACC}(Z) 125 may be determined based on the impulse response G(z) 114 and the impulse response H(z) 112 using the Wiener-Hopf equation, as already described above in the context of the fixed FF filter W_{FF}(Z) 121.

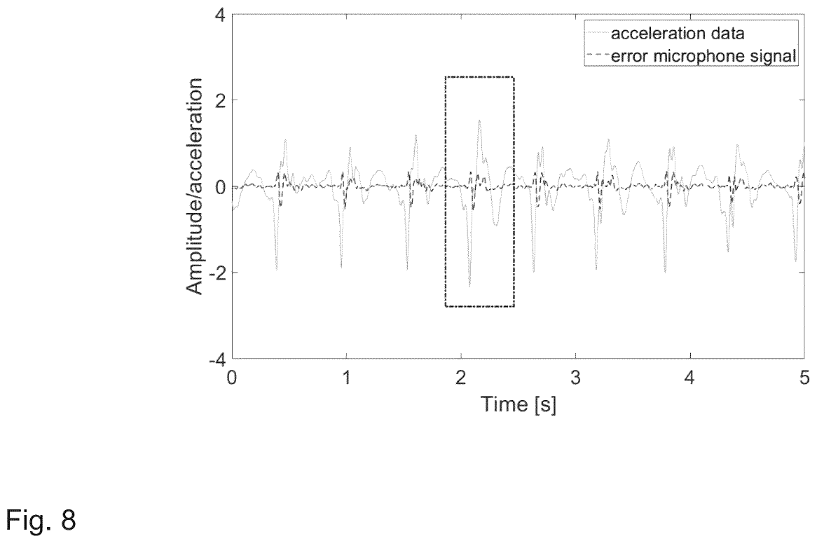

In a further embodiment, the impulse response H(z) 112 and, thus, the FF ACC filter W_{ACC}(Z) 125 may be determined based on data recorded during physical activities of the user while wearing the ANR headphones 100, e.g., walking or running. FIG. 8 shows the recorded acceleration data (up and down direction, solid line) and the residual noise signal (dashed line) while walking on a treadmill, for instance, with a velocity of about 3 km/h and for about 10 to 30 seconds. The impulse-like signals can be considered as the impulse response of H_{SA}(z) and H_{SE}(z). A window can be applied for one or several impulse responses to determine the fixed FF ACC filter W_{ACC}(Z) 125 based on the real data by solving the Wiener-Hopf equation. Thus, in an embodiment, the fixed FF ACC filter W_{ACC}(z) 125 may be determined for individual users.

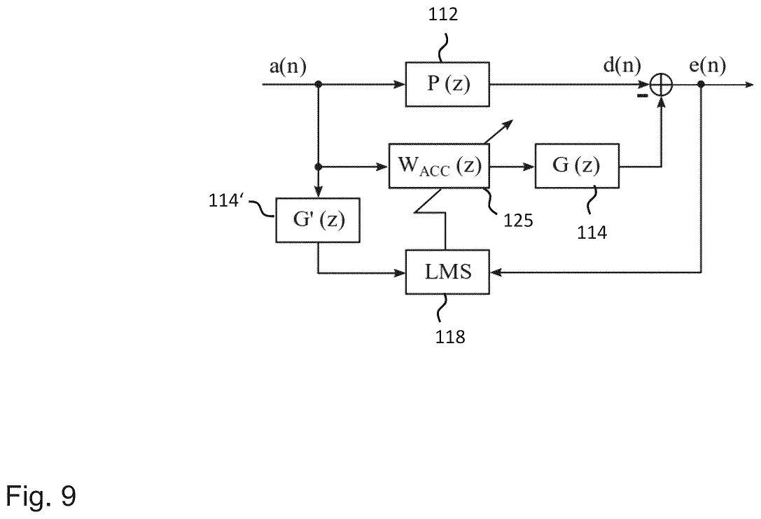

FIG. 9 illustrates an embodiment of the FF ACC filter 125 of the controller 120 of the ANR headphones 100 as an adaptive FF filter, i.e. a filter having adaptive filter coefficients that may vary over time. In the embodiment shown in FIG. 9 the adaptive FF filter W_{ACC}(Z) 125 is based on a filtered-x least mean square (FxLMS) algorithm (similar to FIG. 3). As illustrated in FIG. 9, the adaptive FF filter W_{ACC}(Z) 125 may be updated in real-time based on the recorded acceleration signal a(n) and the residual noise signal, i.e. the error signal e(n). The recorded acceleration signal a(n) may be first filtered through the estimated secondary path G′(z) 114′, which is an approximation of the acoustic transfer path G(z) 114 between the loudspeaker 107 and the internal microphone 103. Then, the filtered acceleration signal a(n) and the residual noise signal e(n) are fed into a LMS (least mean square) processing block 118 implemented by the controller 120 for estimating the acoustic transfer function of the adaptive FF ACC filter W_{ACC}(Z) 125. The recorded acceleration signal a(n) is filtered by the estimated adaptive FF filter W_{ACC}(Z) 125 and reproduced with the loudspeaker 107.

In an embodiment, the FxLMS algorithm implemented by the controller 120 in the LMS processing block 118 of the ANR headphones 100 can be expressed as:

e(n)=d(n)−g^{T}(n)[w^{T}(n)a(n)],

w_{ACC}(n+1)=w_{ACC}(n)−μ[g′^{T}(n)a(n)]e(n),
where n denotes a discrete time index, g(n) and g′(n) are the real and approximated impulse responses of the secondary path 114, respectively, w(n)=[w₀(n), w₁(n), . . . , w_{L-1}(n)] is the coefficient of the adaptive FF filter W_{ACC}(Z) 125 with a filter order of L, x(n)=[x(n), x(n−1), x(n−2), . . . , x(n−L+1)] is the recorded acceleration signal vector consisting of the last L samples at time n, and μ denotes the step-size of the adaption process. In an embodiment, the controller 120 of the ANR headphones 100 may be configured to implement a leaky FxLMS algorithm, a FxNLMS algorithm, a band limited FxLMS algorithm, a Kalman-filter based adaptive algorithm and the like for estimating the adaptive FF filter W_{ACC}(Z) 125. In order to ensure the stability of the filtering, in an embodiment, the adaption may be valid, unless the adapted filter FF filter W_{ACC}(Z) 125 exceeds a pre-defined boundary σ, e.g.:

∥w_{ACC}(n+1)∥₂²≤∥w_{ACC,pre}(n)∥₂²+σ.

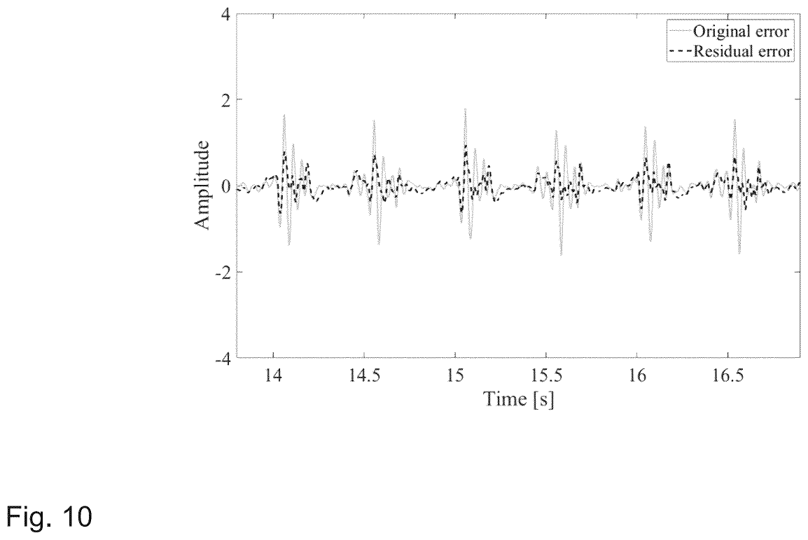

To illustrate the ANR performance of the ANR headphones 100 according to an embodiment a simulation experiment has been performed. A fixed ACC filter W_{ACC,pre} (z) 125 is determined based on the recorded signals when walking on the treadmill with a speed of 3 km/h, as described above in the context of FIG. 8. The such determined fixed ACC filter W_{ACC,pre} (z) 125 is used as the initial filter for further adaptation according to the acceleration data and internal microphone signals, as described in the context of FIG. 9 as above. To evaluate the performance of the ANR headphones 100 according to an embodiment, the ACC FF filter 125 was intentionally tested while walking at a different speed (6 km/h as an example). Thus, the acceleration signals and the internal microphone signals are recorded when walking on the treadmill with a speed of 6 km/h, and the recorded acceleration signals are used as input signals for simulating the compensation signal. FIG. 10 shows the simulation results when applying the adaptive ACC filter 125 for reducing the OE caused by walking. The solid and dashed lines show the OE sound with and without applying the FF ACC filter 125. As can be taken from FIG. 10, the amplitude of the original OE signal is effectively reduced by applying the FF ACC filter 125 of the ANR headphones 100 according to an embodiment.

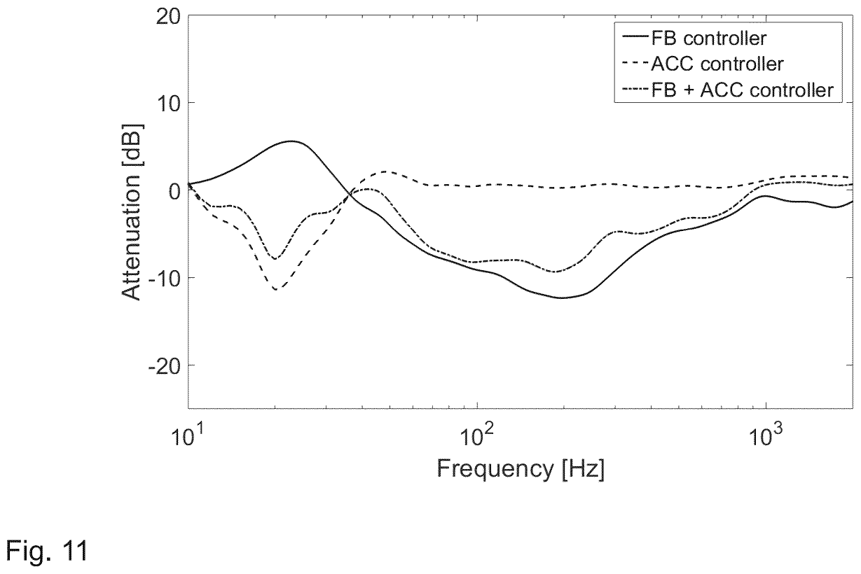

Moreover, the FF ACC filter 125 is combined with the fixed FB ANR filter 123 (designed using a mixed-sensitivity Hoc synthesis algorithm) to reduce the OE caused by walking/running. FIG. 11 shows the attenuation of the OE (the results have been calculated on the basis of one frame of the residual noise signal and are 1/3-octave smoothed) by applying the FB ANR filter 123 only (solid line), the FF ACC controller 125 only (dashed line), and both the FF ACC filter 125 and the fixed FB ANR filter 123 (dotted line) over frequency. As can be taken from FIG. 11, the FB ANC filter 123 is effective in reducing the noise caused by the occlusion effect (OE) between 50 Hz and 800 Hz. Due to the waterbed effect, an amplification of the internal microphone signal can be observed in other frequencies. The FF ACC filter 125 is effective in reducing the OE for low frequencies, which supports the FB ANR filter 123 to reduce the amplification of the OE at low frequencies.

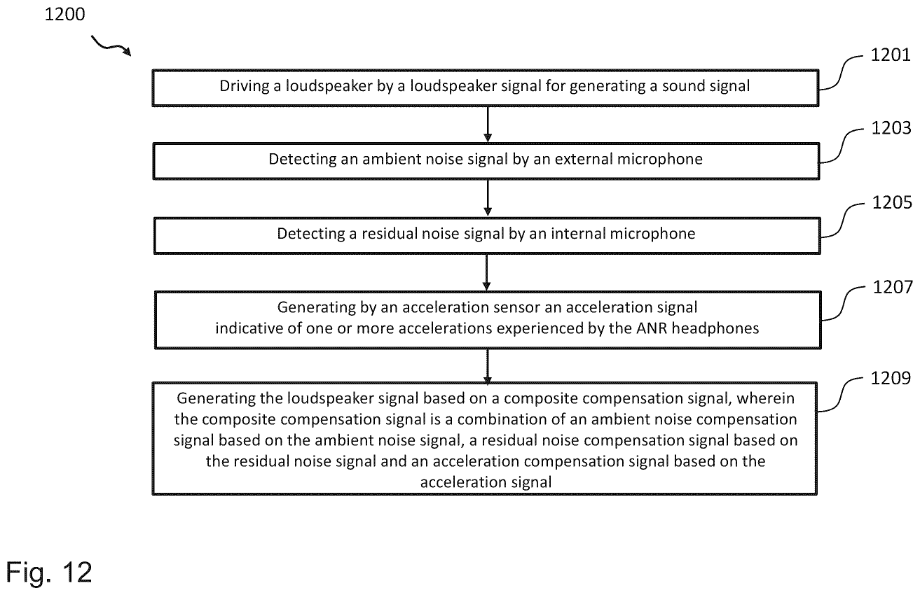

FIG. 12 shows a flow diagram illustrating a method 1200 for operating the active noise reduction, ANR, headphones (100) for generating a sound signal in the ear canal(s) of a user. In an embodiment, the method 1200 may be performed by the ANR headphones 100 and the different embodiments thereof described above.

The method 1200 comprises a step 1201 of driving the loudspeaker 107 by a loudspeaker signal y(n) for generating the sound signal. Moreover, the method 1200 comprises a step 1203 of detecting an ambient noise signal x(n) by the external microphone (101) and a step 1205 of detecting a residual noise signal e(n) in the ear canal of the user by the internal microphone 103. The method 1200 further comprises a step 1207 of generating by the acceleration sensor 105 an acceleration signal a(n) indicative of one or more accelerations experienced by the ANR headphones 100 as a function of time. The method 1200 further comprises a step 1209 of generating the loudspeaker signal y(n) based on a composite compensation signal, wherein the composite compensation signal is a combination, for instance a sum of an ambient noise compensation signal y_{FF}(n) based on the ambient noise signal x(n), a residual noise compensation signal y_{FB}(n) based on the residual noise signal e(n) and an acceleration compensation signal y_{ACC}(n) based on the acceleration signal a(n).

The person skilled in the art will understand that the “blocks” (“units”) of the various figures (method and apparatus) represent or describe functionalities of embodiments (rather than necessarily individual “units” in hardware or software) and thus describe equally functions or features of apparatus embodiments as well as method embodiments (unit=step).

For the several embodiments disclosed herein, it should be understood that the disclosed system, apparatus, and method may be implemented in other manners. For example, the described embodiment of an apparatus is merely exemplary. For example, the unit division is merely a logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units of the embodiments disclosed herein may be integrated into one processing unit, or each of the units may exist alone physically, or two or more units are integrated into one unit.

1. Active noise reduction (ANR) headphones for generating a sound signal, the ANR headphones comprising:
a loudspeaker configured to be driven by a loudspeaker signal for generating the sound signal;
an external microphone configured to detect an ambient noise signal;
an internal microphone configured to detect a residual noise signal;
an acceleration sensor configured to generate an acceleration signal indicative of one or more accelerations experienced by the ANR headphones; and
a controller configured to generate the loudspeaker signal based on a composite compensation signal,
wherein the composite compensation signal is a combination of an ambient noise compensation signal based on the ambient noise signal, a residual noise compensation signal based on the residual noise signal, and an acceleration compensation signal based on the acceleration signal.

2. The ANR headphones of claim 1, wherein the controller is configured to generate the loudspeaker signal based on the composite compensation signal and an audio input signal.

3. The ANR headphones of claim 1, wherein the controller is configured to generate the ambient noise compensation signal based on the ambient noise signal by applying a fixed or adaptive ambient noise feedforward filter to the ambient noise signal.

4. The ANR headphones of claim 1, wherein the controller is configured to generate the residual noise compensation signal based on the residual noise signal by applying a fixed or adaptive feedback filter to the ambient noise signal.

5. The ANR headphones of claim 1, wherein the controller is configured to generate the acceleration compensation signal based on the acceleration signal by applying an acceleration feedforward (FF) filter to the acceleration signal.

6. The ANR headphones of claim 5, wherein the acceleration FF filter is a fixed acceleration FF filter comprising a plurality of fixed filter coefficients and wherein the plurality of fixed filter coefficients of the fixed acceleration FF filter are based on a solution of the Wiener-Hopf equation.

7. The ANR headphones of claim 6, wherein the plurality of fixed filter coefficients W_{ACC} of the fixed acceleration FF filter are based on the following equation:
W_{ACC}=Ψ_{gg}⁻¹ϕ_{hg},
wherein Ψ_{gg} denotes an auto-correlation matrix for the impulse response of the communication channel between the loudspeaker and the internal microphone and ϕ_{hg} denotes a cross-correlation vector between the impulse response and the impulse response of the communication channel between the acceleration sensor and the internal microphone.

8. The ANR headphones of claim 6, further comprising a memory configured to store the plurality of fixed filter coefficients W_{ACC} of the fixed acceleration FF filter.

9. The ANR headphones of claim 7, wherein the impulse response of the communication channel between the acceleration sensor and the internal microphone is based on measurements of the residual noise signal in response to one or more pre-determined accelerations of the ANR headphones.

10. The ANR headphones of claim 7, wherein the impulse response of the communication channel between the acceleration sensor and the internal microphone is based on measurements of the residual noise signal in response to one or more measured accelerations of the ANR headphones.

11. The ANR headphones of claim 5, wherein the acceleration feedforward filter is an adaptive filter comprising a plurality of adaptive filter coefficients.

12. The ANR headphones of claim 11, wherein the controller is configured to determine the plurality of adaptive filter coefficients on the basis of a Filtered-x Least Mean Square, algorithm.

13. The ANR headphones of claim 11, wherein the controller is configured to adjust the plurality of adaptive filter coefficients, if the adjustments of the plurality of adaptive filter coefficients are within one or more pre-defined allowed ranges.

14. The ANR headphones of claim 1, wherein the ANR headphones further comprise an elastic housing configured to be inserted in the ear canal of a user.

15. A method for operating active noise reduction (ANR) headphones for generating a sound signal, the method comprising:
driving a loudspeaker by a loudspeaker signal for generating the sound signal;
detecting an ambient noise signal by an external microphone;
detecting a residual noise signal by an internal microphone;
generating by an acceleration sensor an acceleration signal indicative of one or more accelerations experienced by the ANR headphones; and
generating the loudspeaker signal based on a composite compensation signal,
wherein the composite compensation signal is a combination of an ambient noise compensation signal based on the ambient noise signal, a residual noise compensation signal based on the residual noise signal, and an acceleration compensation signal based on the acceleration signal.

16. A non-transitory computer-readable storage medium storing program code which causes a computer or a processor to perform the method of claim 15, when the program code is executed by the computer or the processor.
